(19) United States
(12) Patent Application Publication
(10) Pub. No.: US 2013/0198181 A1
(43) Pub. Date: Aug. 1, 2013

(54) Summarising a Set of Articles

(71) Applicants: Sihem AMER-YAHIA, Doha (QA); Paul Coyne, Doha (QA); Arend Kuster, Doha (QA)

(72) Inventors: Sihem AMER-YAHIA, Doha (QA); Paul Coyne, Doha (QA); Arend Kuster, Doha (QA)

(73) Assignee: Qatar Foundation, Doha (QA)

(21) Appl. No.: 13/434,589

(22) Filed: Mar. 29, 2012

(30) Foreign Application Priority Data
Feb. 1, 2012 (GB) 1201708.3

(51) Int. Cl. G06F 17/30

(52) U.S. Cl. 707/736; 707/E17.058

(57) ABSTRACT

A computer-implemented method for summarising a set of articles relating to a topic, comprises using metadata of respective articles in the set to generate multiple subsets of articles, each article within a subset linked by a common article parameter, summarising content of the articles in a subset by extracting key phrases from constituent articles, editing extracted summaries for respective ones of the subsets of articles according to a predetermined optimisation goal to generate an article review for the topic.

### CROSS REFERENCE TO RELATED APPLICATIONS

This application claims foreign priority from UK Patent Application Serial No. 1201708.3, filed 1 Feb. 2012.

### BACKGROUND

The growth of published literature, whether in paper format or online, is exponential. This has made the task of reviewing the literature time consuming and difficult. Consequently, it may no longer be possible to simply keep ‘up-to-date’ by reading the latest literature from time to time, as the volume of published material exceeds human limits to read or understand it all.

Systems exist which attempt to compile the information contained within a number of documents from the corpus of published literature in order to synthesize a summary of the core information so that an individual need only access the summary rather than all of the documents that were used to generate it. The task of synthesis is typically manual, and the human resources that can be devoted to activities that synthesize and summarise knowledge from the literature are relatively fixed. Accordingly, there is a vast amount of information available in the published literature which cannot be sensibly reviewed.

### SUMMARY

According to an example, there is provided a method and a system for reviewing and summarizing multiple articles based on a topic. The articles can be those from the published literature or more generally articles which relate to certain topics and which can be published online in the form of a webpage or website for example.

According to an example there is provided a computer-implemented method for summarising a set of articles relating to a topic, comprising using metadata of respective articles in the set to generate multiple subsets of articles, each article within a subset linked by a common article parameter summarising content of the articles in a subset by extracting key phrases from constituent articles editing extracted summaries for respective ones of the subsets of articles according to a predetermined optimisation goal to generate an article review for the topic. The articles are typically retrieved from multiple sources. A threshold value for a summary can be set relating to a quality measure for the summary, the method further including providing a stable state for a summary when the threshold value is reached. The threshold value can represent a number of positive votes. An assignment threshold value for a participating editor can be used to distribute a summary for editing. The assignment threshold value can represent a measure for the knowledge, expertise or workload of the participating editor.

A common article parameter includes a predetermined temporal range of publication of articles, an author, and a reference within an article. In an example, an optimisation goal can be used to control a level of editing on extracted summaries. Editing extracted summaries can include receiving user input representing a proposed change for a summary.

According to an example, there is provided a system for summarising a set of articles relating to a topic, comprising a metadata extractor to extract metadata from a set of articles, a segmentation engine to use the metadata to generate multiple subsets from the set of articles, a summary module to generate summaries for respective ones of the subsets according to an optimization goal. The segmentation engine can determine multiple common article parameters for the set of articles, and to generate the multiple subsets using the common parameters. The segmentation engine can allocate an article to a subset if that article has an article parameter in common with other articles in the subset. The segmentation engine can determine a common article parameter from a set including a predetermined temporal range of publication of articles, an author, and a reference within an article. In an example, an optimisation goal can be used to control a level of editing on generated summaries. The summary module can receive user input representing a proposed change for a summary. The summary module can be operable to distribute summaries according to an assignment threshold value representing a measure for the knowledge, expertise or workload of an editor for the system.

According to an example, there is provided a computer program embedded on a non-transitory tangible computer readable storage medium, the computer program including machine readable instructions that, when executed by a processor, implement a method for summarising a set of articles relating to a topic comprising using metadata of respective articles in the set to generate multiple subsets of articles, each article within a subset linked by a common article parameter summarising content of the articles in a subset by extracting key phrases from constituent articles, editing extracted summaries for respective ones of the subsets of articles according to a predetermined optimisation goal to generate an article review for the topic. The implemented method can further comprise using an assignment threshold value to distribute a summary to an editor.

### BRIEF DESCRIPTION OF THE DRAWINGS

An embodiment of the invention will now be described, by way of example only, and with reference to the accompanying drawings, in which:

FIG. 1 is a schematic block diagram of a system according to an example;

FIG. 2 is a schematic block diagram of a system according to an example;

FIG. 3 is a schematic block diagram of a system according to an example; and

FIG. 4 is a flowchart of a method according to an example.

### DETAILED DESCRIPTION

It will be understood that, although the terms first, second, etc. may be used herein to describe various elements, these elements should not be limited by these terms. These terms are only used to distinguish one element from another. The terminology used herein is for the purpose of describing particular examples only and is not intended to be limiting. As used herein, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

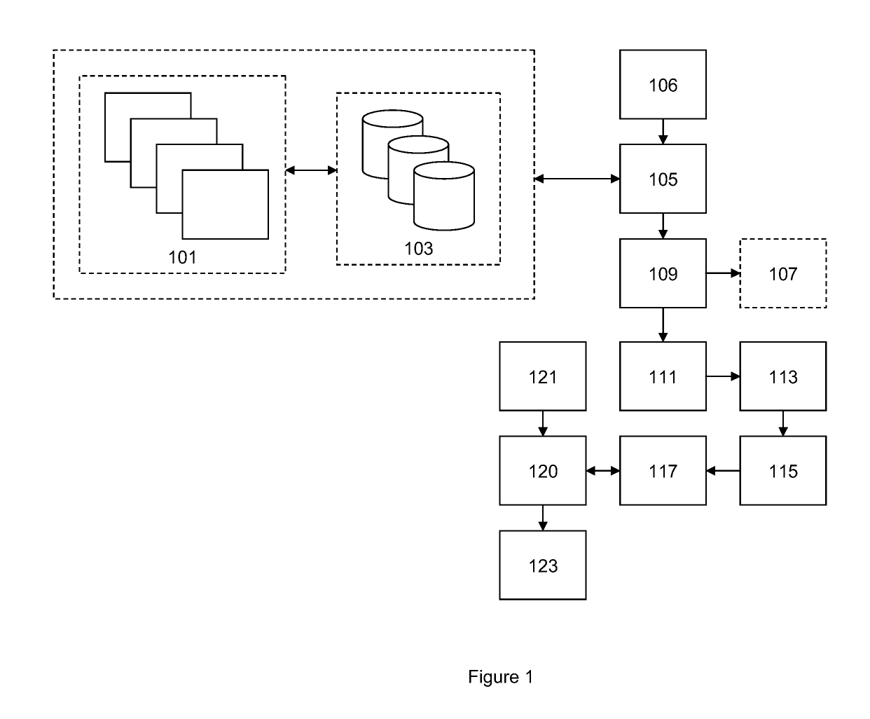

FIG. 1 is a schematic block diagram of a system according to an example. A corpus of articles 101 spanning multiple different sources 103 and relating to multiple topics can be searched using a search engine 105, which can be a search engine proper, or search functionality for a document repository. Multiple different search engines or sources can be used, each of which can be geared for searching within or providing documents from a particular source or set of sources for example.

In an example, a user 106 thus uses a search engine or document source 105 to query the sources 103 for a set of articles relating to a topic of interest 107. A set of articles 109 relating to topic 107 is retrieved by or from the search engine or source. Typically, input terms can be used to perform a query which outputs a set of search results in the form of web pages, images, information and other types of files for example. A document source can be a digital library or repository for example. Similarly to a search engine, an input query can be used to return a set of matching results from the library. Accordingly, a user 106 can performs a composite retrieval across multiple sources.

An article typically includes metadata such as information relating to topics, authors and citations for example which is used to generate multiple sets of complementary articles. With reference to FIG. 1, metadata 111 for the retrieved articles 109 is used to generate multiple sets of complementary articles 113 in which complementary conditions for the articles 109 such as the authors and time (or a temporal range) of publication for example are used to group related articles together. For example, a set of articles which relate to a topic 107 can be retrieved from the multiple sources 103 and grouped into subsets based on certain metadata associated with the articles.

Articles can be bundled into subsets based on their metadata such as authors, scientific venue, publication date, keywords, citations but also using content overlap between articles and other semantic relationships such as “an article is a journal version of a conference article and will hence contain the scientific contributions in the conference article and extend them”. In an example, the number of subsets can be a parameter that can be set by a user or which is otherwise predetermined. In an example, a subset can correspond to a sub-topic of an original topic. For example, “in-memory query processing” is a sub-topic of the more general topic “query optimization”.

One subset can be a grouping in which articles for the topic 107 have an article parameter such as an author in common for example. Another subset can include articles which have a common article parameter such as a date of publication which is within a certain predetermined date range, or before or after a certain date for example. Another subset can include articles which have a common article parameter such as a common citation for example.

Typically, sources will provide metadata. For example, articles from different sources, even if they do not obey the same structure, will generally include a title, abstract, keywords, authors, publication date, scientific venue (journal or conference), citations (bibliographic references) and so on. Metadata in this form can be extracted from an article in one of the typically known ways for word recognition and extraction. In the example that an article or document has been retrieved in a form in which text is not directly recognizable, either character recognition can be performed in order to place the article or document into a form where text can be readily extracted, or, oftentimes, such an article or document will be accompanied by recognizable metadata which can be used. For example, in order for the article or document to be indexed by a search engine or document repository, certain parameters relating to the content and authors and so on will be available.

In an example, an article can exist in one subset. In another example, an article can exist in multiple subsets if the metadata for that article dictates that it fulfils one or more complementary conditions. For example, an article covering two sub-topics of an input topic can reside in multiple subsets in the case where the subsets relate to the different subtopics. Similarly, an article whose authors overlap with different subsets of authors of other articles can reside in to multiple subsets.

The subsets 113 are summarized in block 115 by extracting key phrases from their constituent articles. The subsets 113 are preserved, but data 117 representing one or more summaries for respective ones of the subsets 113 is generated. In an example, a summary can include a word or multiple words representative of the content of the articles for a subset. Typically, a summary will include a snippet in the form of a phrase which is representative of the content of the articles for a subset.

In an example, given an article a summary can be produced by extracting key phrases. A key phrase is typically one that contains the highest number of important words in the article. Then, article summaries can be grouped together to form the summary of a subset. If there is a lot of overlap in content between articles the most recent article can be selected and summarized to represent the subset. In block 120 summaries 117 are collaboratively edited by editors 121 to generate a coherent literature review 123 on the topic 107. This enables the specification of an optimization goal in order to manage the changes proposed by participating editors.

In an example, an optimization goal can include a predetermined time limit for each editor, which can be set according to their expertise and the number of subset summaries to be edited. Accordingly, there can be two steps: i) based on the expertise of each editor (where expertise can be related to a set of keywords representing what the editor knows, or what their specialism is for example), a set of summaries can be assigned to each editor so that the workload is balanced between all of them; ii) a collaborative editing model can be generated within which editing is optimized. For example, each editor is only allowed to edit a summary once (and could edit multiple summaries). An editor can also vote on a summary. A vote can be positive or negative. If a positive vote is received from an editor, it can provide an indication that the editor considers that a stable state for the summary is reached. That is, that the summary is in an acceptable form, such as following certain edits and changes for example. A negative vote can indicate the contrary position, and show that further work is required for a summary in order for it to be considered in a stable or acceptable state.

Therefore, in an example, a threshold value for a summary relating to a quality measure for the summary can be provided. Such a value can be predetermined over all summaries, or set independently for each summary. A threshold value can be set according to a summary length or subject-matter. For example, a longer summary which may require more editing can have a relatively higher threshold. A summary which relates to a topic for the subject-matter is considered complex can have a relatively higher threshold. In an example, a negative vote can decrement a positive vote count.

According to an example, an optimisation goal in the form of an assignment threshold value can be provided for summary assignment and for editing. That is, the way in which summaries are distributed across participating editors can be measured in order to optimise the distribution. For example, summaries can be distributed according to subject-matter so that only editors with relevant knowledge or expertise can edit. Summaries can be distributed according to participating editor workload. For example, summaries can be preferentially distributed to editors with fewer pending summary reviews than editors with relatively more pending reviews. This can be in addition to, or independent of a requirement to distribute according to subject matter. An optimisation goal for distribution can be independent to an optimisation goal for collaborative editing.

In an example, given a summary and a time budget, a goal is to find an order in which editors can edit the summary so as to get it to a stable state within the time budget. A stable state can include a state for the summary in which no more edits are proposed by editors, or where a threshold vote for an acceptable state is reached. In another example, each editor can edit a summary as many times as he/she wants with no time limit. Editors can also talk to each other and there is no notion of a vote. An optimization goal both for summary assignment and for collaborative editing can be defined.

Accordingly, related articles are automatically grouped into bundles, and through the use of text summarization tools, summaries of the bundles can be generated. Humans are introduced into the loop to refine the summary of each bundle according to an optimization goal.

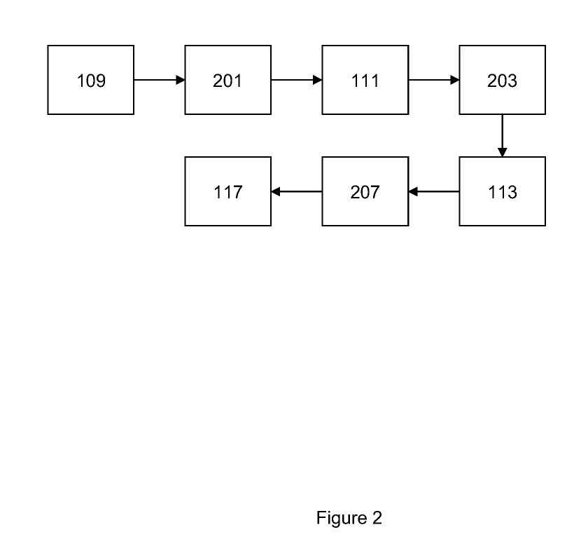

FIG. 2 is a schematic block diagram of a system according to an example. A metadata extractor 201 is used to extract metadata 111 from an article in a set of retrieved articles 109. The metadata 111 is used by a segmentation engine 203 to generate multiple subsets 113 of the articles 109 based on certain metadata associated with the articles as described above. A summary module 207 generates summaries 117 for respective ones of the subsets 117. For example, module 207 can take data representing the text of articles in a subset 113 and process it to determine a summary for that article. This can be repeated across other articles in the subset in question, and the results aggregated or otherwise combined in some way to arrive at a summary for the subset.

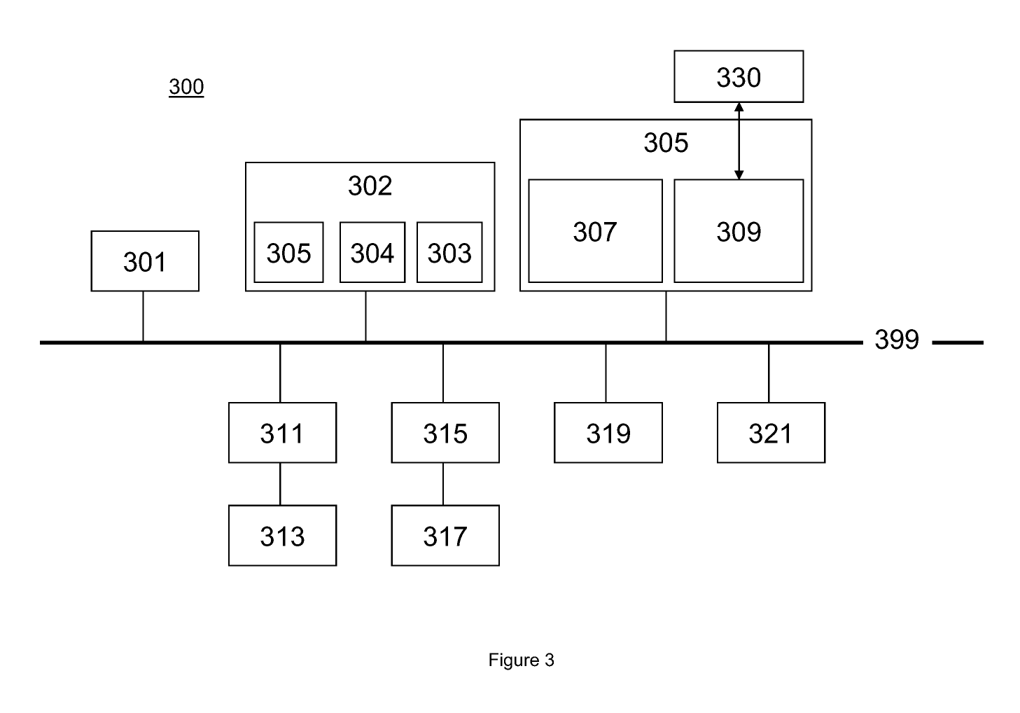

FIG. 3 is a schematic block diagram of a system according to an example suitable for implementing any of the methods or processes described above. Apparatus 300 includes one or more processors, such as processor 301, providing an execution platform for executing machine readable instructions such as software. Commands and data from the processor 301 are communicated over a communication bus 399. The system 300 also includes a main memory 302, such as a Random Access Memory (RAM), where machine readable instructions may reside during runtime, and a secondary memory 305. The secondary memory 305 includes, for example, a hard disk drive 307 and/or a removable storage drive 330, representing a floppy diskette drive, a magnetic tape drive, a compact disk drive, etc., or a nonvolatile memory where a copy of the machine readable instructions or software may be stored. The secondary memory 305 may also include ROM (read only memory), EPROM (erasable, programmable ROM), EEPROM (electrically erasable, programmable ROM). In addition to software, data representing any one or more of a website 100, webpage, article, topic, metadata extractor, segmentation engine or summary module may be stored in the main memory 302 and/or the secondary memory 305. The removable storage drive 330 reads from and/or writes to a removable storage unit 309 in a well-known manner.

A user can interface with the system 300 with one or more input devices 311, such as a keyboard, a mouse, a stylus, and the like in order to provide user input data and to provide input relating to the editing of a summary or set of summaries for example. The display adaptor 315 interfaces with the communication bus 399 and the display 317 and receives display data from the processor 301 and converts the display data into display commands for the display 317. A network interface 319 is provided for communicating with other systems and devices via a network (not shown). The system can include a wireless interface 321 for communicating with wireless devices in the wireless community.

It will be apparent to one of ordinary skill in the art that one or more of the components of the system 300 may not be included and/or other components may be added as is known in the art. The apparatus 300 shown in FIG. 3 is provided as an example of a possible platform that may be used, and other types of platforms may be used as is known in the art. One or more of the steps described above may be implemented as instructions embedded on a computer readable medium and executed on the system 300. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running a computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated above may be performed by any electronic device capable of executing the above-described functions.

According to an example, a metadata extractor 303, segmentation engine 304 and summary module 305 can reside in memory 302 and operate on data representing articles 109, metadata 111 and summaries 117 for example.

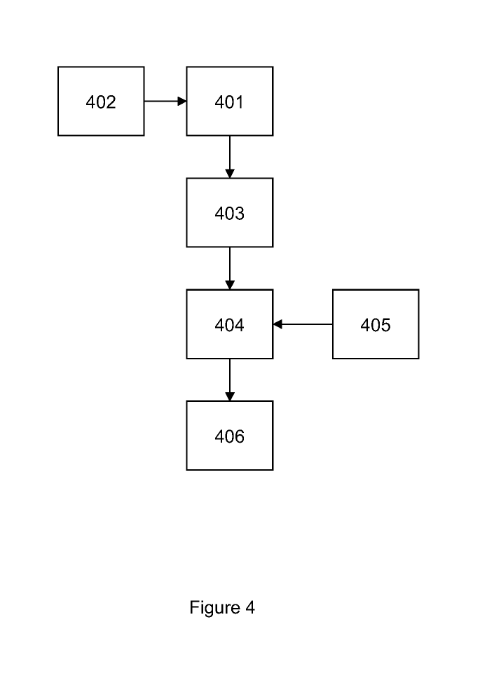

FIG. 4 is a flowchart of a method according to an example. In block 401 metadata of respective articles from a set of articles 402 is used to generate multiple subsets of articles, wherein each article within a subset is linked by a common article parameter. In block 403 the content of the articles in a subset is summarised by extracting key phrases from constituent articles. In block 404 extracted summaries for respective ones of the subsets of articles are edited using an optimisation goal 405 to generate an article review for the topic. The optimisation goal can relate to one or both of assignment and collaborative editing. That is, goal 405 can include components relating to the distribution of a summary and the level of editing. One component may have an effect on the other. For example, if an assignment goal specifies that certain summaries are distributed in a certain way, the editing component may be adjusted to account for the fact that editing may or may not be compromised as a result of this. For example, if a summary can only be distributed in a certain non-optimal way due to a workload or expertise measure of certain editors, the editing component can be adjusted to specify a lesser or greater threshold as desired. In block 406 a stable state for a summary is provided. The stable state represents a final or acceptable state for a summary.

What is claimed is:

1. A computer-implemented method for summarising a set of articles relating to a topic, comprising:
using metadata of respective articles in the set to generate multiple subsets of articles, each article within a subset linked by a common article parameter;
summarising content of the articles in a subset by extracting key phrases from constituent articles;
editing extracted summaries for respective ones of the subsets of articles according to a predetermined optimisation goal to generate an article review for the topic.

2. A computer-implemented method as claimed in claim 1, wherein the articles are retrieved from multiple sources.

3. A computer-implemented method as claimed in claim 1, wherein a common article parameter includes a predetermined temporal range of publication of articles, an author, and a reference within an article.

4. A computer-implemented method as claimed in claim 1, wherein the optimisation goal includes a predetermined period of time for editing the extracted summaries.

5. A computer-implemented method as claimed in claim 1, wherein editing extracted summaries includes receiving user input representing a proposed change for a summary.

6. A computer-implemented method as claimed in claim 1, further including setting a threshold value for a summary relating to a quality measure for the summary, the method further including providing a stable state for a summary when the threshold value is reached.

7. A computer-implemented method as claimed in claim 1, further including setting a threshold value for a summary relating to a quality measure for the summary, the method further including providing a stable state for a summary when the threshold value is reached, wherein the threshold value represents a number of positive votes.

8. A computer-implemented method as claimed in claim 1, further including using an assignment threshold value for a participating editor to distribute a summary for editing.

9. A computer-implemented method as claimed in claim 1, further including using an assignment threshold value for a participating editor to distribute a summary for editing, wherein the assignment threshold value represents a measure for the knowledge, expertise or workload of the participating editor.

10. A system for summarising a set of articles relating to a topic, comprising:
a metadata extractor operable to extract metadata from a set of articles;
a segmentation engine operable to use the metadata to generate multiple subsets from the set of articles;
a summary module operable to generate summaries for respective ones of the subsets according to an optimization goal.

11. A system as claimed in claim 10, the segmentation engine operable to determine multiple common article parameters for the set of articles, and to generate the multiple subsets using the common parameters.

12. A system as claimed in claim 11, the segmentation engine being operable to determine multiple common article parameters for the set of articles, and to generate the multiple subsets using the common parameters and to allocate an article to a subset if that article has an article parameter in common with other articles in the subset.

13. A system as claimed in claim 10, the segmentation engine being operable to determine a common article parameter from a set including a predetermined temporal range of publication of articles, an author, and a reference within an article.

14. A system as claimed in claim 10, wherein the optimisation goal is used to control a level of editing on generated summaries.

15. A system as claimed in claim 10, the summary module further being operable to distribute summaries according to an assignment threshold value representing a measure for the knowledge, expertise or workload of an editor for the system.

16. A system as claimed in claim 10, the summary module being operable to receive user input representing a proposed change for a summary.

17. A computer program embedded on a non-transitory tangible computer readable storage medium, the computer program including machine readable instructions that, when executed by a processor, implement a method for summarising a set of articles relating to a topic comprising:
using metadata of respective articles in the set to generate multiple subsets of articles, each article within a subset linked by a common article parameter;
summarising content of the articles in a subset by extracting key phrases from constituent articles;
editing extracted summaries for respective ones of the subsets of articles according to a predetermined optimisation goal to generate an article review for the topic.

18. The computer program embedded on a non-transitory tangible computer readable storage medium as claimed in claim 17 further comprising instructions that, when executed by the processor, implement a method for summarising a set of articles relating to a topic further comprising:
using an assignment threshold value to distribute a summary to an editor.
